(19) United States
(12) Patent Application Publication
(10) Pub. No.: US 2024/0084941 A1
(43) Pub. Date: Mar. 14, 2024

(54) EMERGENCY COUPLING AND RELEASE DEVICE

(71) Applicant: L'AIR LIQUIDE, SOCIETE ANONYME POUR L'ETUDE ET L'EXPLOITATION DES PROCEDES GEORGES CLAUDE, Paris (FR)

(72) Inventors: Gaetan COLEIRO, Sassenage (FR); Yan PENNEC, Sassenage (FR)

(73) Assignee: L'AIR LIQUIDE, SOCIETE ANONYME POUR L'ETUDE ET L'EXPLOITATION DES PROCEDES GEORGES CLAUDE, Paris (FR)

(21) Appl. No.: 18/273,118

(22) PCT Filed: Jan. 12, 2022
(86) PCT No.: PCT/EP2022/050496

§ 371 Date: Jul. 19, 2023

(30) Foreign Application Priority Data
Jan. 19, 2021 (FR) FR 2100473

(51) Int. Cl. F16L 37/35; F17C 5/00

(52) U.S. Cl. CPC F16L 37/35; F17C 5/00; F16L 2201/20; F17C 2205/0323; F17C 2205/0355; F17C 2205/037; F17C 2221/012; F17C 2223/0161

(57) ABSTRACT

Disclosed is a self-closing emergency coupling and release device for the transport of cryogenic fluid, comprising two fluid transport pipes extending in a longitudinal direction and each comprising, at a connection end, a valve mechanism configured to automatically close the pipe when the connection ends are separated and to open the pipe when the connection ends are coupled, the device further comprising an outer tube arranged around each transport pipe and delimiting a vacuum space for thermally insulating the transport pipe, the device further comprising a mechanism for holding the transport pipe in the outer tube, characterized in that the holding mechanism comprises a frustoconical connection tube having a first end connected to the outer tube and a second end connected to the transport pipe.

### CROSS REFERENCE TO RELATED APPLICATIONS

This application is a § 371 of International PCT Application PCT/EP2022/050496, filed Jan. 12, 2022, which claims the benefit of FR2100473, filed Jan. 19, 2021, both of which are herein incorporated by reference in their entireties.

### FIELD OF THE INVENTION

The invention concerns an emergency coupling and release device.

### SUMMARY OF THE INVENTION

More particularly, the invention concerns a self-closing emergency coupling and release device for the transport of cryogenic fluid, comprising two fluid transport ducts extending in a longitudinal direction, and each comprising, at a connection end, a valve mechanism which is configured to close the duct automatically when the connection ends are separated, and to open the duct when the connection ends are coupled, the device also comprising an outer tube which is placed around each transport duct, and defines a space under vacuum for thermal insulation of the transport duct, the device comprising a mechanism for holding the transport duct in the outer tube.

The invention concerns a cryogenic fluid (for example liquid hydrogen)transport pipe(s) system which is insulated such as to limit the thermal inputs, and allow the pipes to be disconnected during an emergency event without loss or spillage of fluid.

These devices are generally designated by the term “breakaway” (cf. for example EP3581839 A1). The known devices have thermal performance levels which are unsatisfactory and/or a complex structure and/or disadvantageous ergonomics of use.

An objective of the present invention is to eliminate some or all of the disadvantages of the prior art indicated above.

In an effort to overcome the deficiencies of the prior art discussed, supra, the coupling device according to certain embodiments of the invention has a holding mechanism that includes a frustoconical connection tube with a first end which is connected to the outer tube, and a second end which is connected to the transport duct.

An objective of certain embodiments of the present invention is to eliminate some or all of the disadvantages of the prior art indicated above.

In addition, embodiments of the invention can comprise one or more of the following characteristics:
the first end of the connection tube is connected to the outer tube at an annular outer flange which is fitted at the terminal end of said outer tube, said outer flange being configured to cooperate in a sealed manner with the adjacent outer flange when the connection ends are coupled;
the second end of the connection tube is connected to the transport duct at an annular inner flange which is fitted at the terminal end of said transport duct;
the inner flange is configured to cooperate in a non-sealed manner with the adjacent inner flange when the connection ends are coupled, in order to permit the migration of any leakages of cryogenic fluid, and form a pocket of gas at the junction of, and/or between the connection tubes of, the two coupled connection ends;
the connection tube has a thickness of between 0.3 mm and 0.5 mm and a length of between 10 mm and 500 mm, and constitutes an insulating thermal path between the two ends thereof;
the second end of the connection tube of a first one of the two ducts is situated in the interior of the outer tube to which it is connected, whereas the second end of the connection tube of the other one of the two ducts projects on the exterior of the outer tube to which it is connected, such as to form a nesting system of the male and female type;
at least one of the first and second ends of the connection tube comprises a guide part, for example with an annular form, which is designed to come into contact with the tube or a flange of the other duct during the coupling;
the at least one guide part is composed of a material with a low coefficient of friction, for example lower than 0.3, relative to the tube or to the flange, coming into contact during the coupling, the material being for example PTFE (polytetrafluoroethylene);
the at least one guide part is configured to ensure sealed contact with the tube or the flange of the other duct during the coupling;
the valve mechanism comprises a valve which is thrust towards a position of closure against a seat by a return unit;
the seat comprises a seal which is designed to cooperate with the valve, in order to ensure the sealing in the position of closure;
the seal of the seat is situated on the inner flange, on a face of said inner flange which faces towards the interior of the transport duct;
the terminal ends of the valves of the two transport ducts are configured to come into contact with one another, and to force one another back mechanically out of the respective seats, against the return units, when the connection ends are coupled;
the inner flange is secured on the end of the inner tube via a set of fitting units such as screws, which, during dismantling of the flange, permit access to the mechanism of the valve and of the seals of the device;
the support tube comprises a plurality of portions of tube connected in series between the first end which is connected to the outer tube, and the second end which is connected to the transport duct;
the plurality of connected portions of tube forming the support tube comprises two portions of tube which are convergent in opposite directions according to the direction of transport of the fluid;
the space under vacuum between the outer tube and the transport duct comprises a multilayer thermal insulator “MLI”.

According to other possible particular features, at least one of the outer flanges comprises a system of joints which cooperates with the adjacent flange in the coupled position, in order to ensure the sealing, for example an annular seal, which can be composed of a polymer.

The invention can also concern any alternative device or method comprising any combination of the characteristics above or below within the context of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 represents a schematic, partial view in longitudinal cross-section, illustrating an embodiment of a coupling device according to the invention in a separated configuration;

FIG. 2 represents a schematic, partial view in longitudinal cross-section, illustrating an embodiment of a coupling device according to the invention in a coupled configuration;

FIG. 3 represents a schematic, partial view in longitudinal cross-section, according to yet another embodiment of a coupling device according to the invention, in a coupled configuration.

### DETAILED DESCRIPTION OF THE INVENTION

The self-closing device 1 for emergency coupling and release for the transport of cryogenic fluid illustrated comprises two ducts 2, 3 for transport of fluid extending in a longitudinal direction A. Each transport duct 2, 3 can be composed of stainless steel or any other material which is compatible with cryogenic temperatures (lower than −100° C. for example).

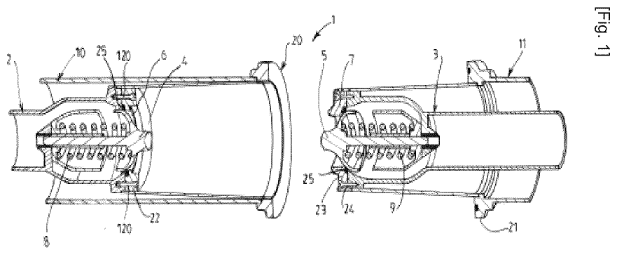

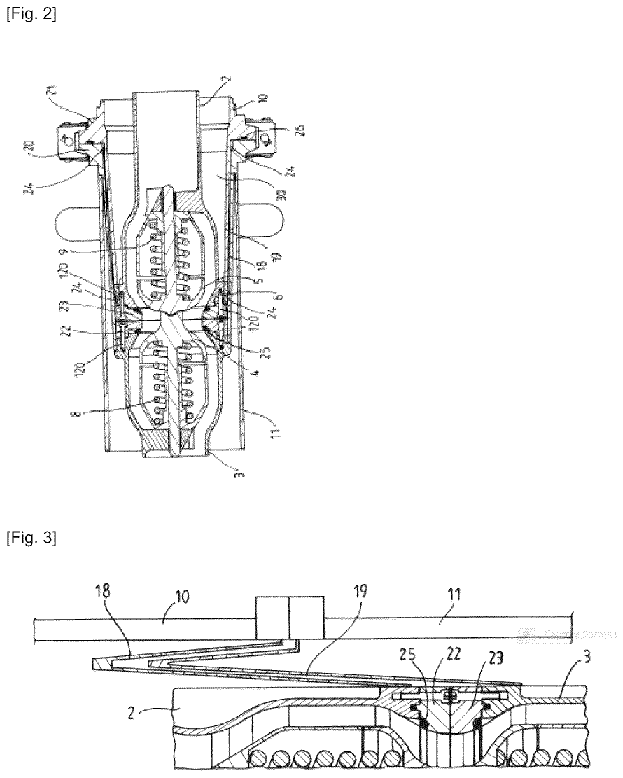

At a connection end, each transport duct 2, 3 comprises a valve mechanism 4, 6, 8; 5, 7, 9 which is configured to close the duct automatically when the connection ends are separated (cf. [FIG. 1]) and to open when the connection ends are coupled (cf. [FIG. 2] in particular).

The valve mechanism can comprise a valve 4, 5, which is thrust towards a position of closure against a seat 6, 7 by a return unit 8, 9, such as a spring, in particular a compression spring.

The terminal ends of the valves 4, 5 of the two transport ducts 2, 3 can be configured to come into contact and to force one another back out of the respective seats against the return units 5, 9, when the connection ends are coupled.

For example, the terminal ends of the valves 4, 5 of the two ducts 2, 3 project longitudinally beyond the ends of the transport ducts 2, 3 (and can in particular comprise complementary forms if applicable).

The device 1 may also include an outer tube 10, 11 (made of stainless steel, metal or another material) placed around each transport duct 2, 3 (for example concentrically) and defining a space under vacuum around the transport duct 2, 3 for thermal insulation thereof.

This space under vacuum can contain a thermal insulator 30, for example of the multilayer type (MLI).

The device 1 may include a mechanism for holding the transport duct 2, 3 in the outer tube 10, 11. This holding mechanism can include a frustoconical connection tube 18, 19 with a first end which is connected to the outer tube 10, 11, and a second end which is connected to the transport duct 2, 3. Each connection tube 18, 19 converges from the first end towards the second.

The first end of the connection tube 18, 19 can be connected to the outer tube 10, 11 at an annular outer flange 20, 21, which is fitted at the terminal end of said outer tube 10, 11.

The outer flange 20, 21 may be configured to cooperate in a sealed manner with the adjacent outer flange 21, 20, when the connection ends are coupled (cf. [FIG. 2] onwards).

The second end of the connection tube 18, 19 can be connected to the transport duct 2, 3 at an annular inner flange 22, 23, which is fitted at the terminal end of said transport duct 2, 3.

Preferably, the tube 18, 19 is composed of metal, stainless steel, or any other appropriate material, and can have a thickness of between 0.3 mm and 0.5 mm and a length of between 10 mm and 500 mm. This configuration constitutes an insulating thermal path between its two ends.

The second end of the connection tube 18 of a first one of the two ducts can be situated in the interior of the outer tube 10, to which it is connected, whereas the second end of the connection tube 19 of the other one of the two ducts can project on the exterior of the outer tube 11 to which it is connected. This forms a nesting system of the male and female type as illustrated.

At least one of the first and second ends of the connection tube 18, 19 can comprise a guide part 24, which for example has an annular form, designed to come into contact with the tube 19, 18 or a flange 22, 23 of the other duct during the coupling.

These guide parts 24 can be composed of a material with a low coefficient of friction, for example lower than 0.3, relative to the tube or the flange, coming into contact during the coupling, the material being for example PTFE (polytetrafluoroethylene). These guide parts can in particular.

These guide parts 24 facilitate the connection and disconnection of the two parts. In particular, they also ensure protection during the phases of connection/disconnection, and prevent the risks of blocking.

The inner flange 22, 23 is preferably configured to cooperate in a non-sealed manner with the adjacent inner flange 23, 22 when the connection ends are coupled. This permits the migration of any leakages of cryogenic fluid in order to form a pocket of gas at the junction of, and/or between the tubes 18, 19 for connection of the two coupled connection ends.

Advantageously, at least one guide part 24 can be configured to ensure a sealed contact with the tube 19, 18 or the flange of the other duct, during coupling below a pressure differential. This makes it possible if applicable to maintain pockets of gas below a pressure threshold upstream from this sealed contact (but which contact opens when the situation requires it).

The sealing between the valve 4, 5 and its seat (formed for example by the inner flange 22, 23) can comprise a seal 25, in particular a lip seal (for example made of PTFE or energised polymer). Said seal 25 of the seat is advantageously situated on the inner flange 22, 23, on a face of said inner flange 22, 23, and oriented towards the interior of the transport duct 2, 3. This protects these sensitive sealing elements against impacts, scratches and dirt. The force of the spring 8, 9 permits sealed closure between the flange 22, 23 and the valve 4, 5, via the seal 25, without risk of leakage.

This ensures considerable reliability after multiple opening/closure cycles, and sealing at any temperature level. The positioning of the valve, which can withstand considerable pressure differentials, is facilitated.

The inner flange 22, 23 with an annular form can be secured on the end of the inner tube 2, 3 via a set of fitting units 120 such as screws, which, during dismantling of the flange 22, 23, preferably permit access to the mechanism 4, 6, 8; 5, 7, 9 of the valve and of any seals of the device 1. This facilitates the maintenance. In particular, the thread of the screws 120 can be oriented longitudinally towards the interior of the duct.

As illustrated in [FIG. 3], the support tube 18, 19 can comprise a plurality of portions of tube connected in series between the first end connected to the outer tube 10, 11, and the second end connected to the transport duct 2, 3. As illustrated, the plurality of connected tube portions forming the support tube 18, 19 can comprise at least two portions of tube, which are convergent in opposite directions according to the longitudinal direction of transport of the fluid. These back-and-forth routes contribute towards elongating the thermal insulation path, without elongating the connection mechanism excessively longitudinally.

Some or all of the parts can be secured by welding.

When the connection ends are coupled, the ends of the two outer tubes 10, 11 are connected in a sealed manner, and the ends of the two transport ducts 2, 3 are connected in a sealed manner. This can be obtained by means of a set of appropriate seals.

For example, the sealing between the outer tubes 10, 11 can be ensured at least partly by one or more seals 26 at ambient temperature, interposed between the outer flanges 20, 21 (seal(s) of the type made of polymer or another material). This positioning at the largest diameter of the device 1 permits improved control of the thermal expansions. In particular, the level of leakage is reduced since the seal contracts towards the interior, and increases the forces in the direction of the sealing.

If sealing is provided between the two transport ducts 2, 3, it can be ensured at least partly by one or more seals interposed between the inner flanges 22, 23, for example a metal cryogenic seal, in particular of type “C”, which is radial.

The device has good-quality insulation, which is compatible with cryogenic temperatures, automatic opening or closure of the valves, and considerable reliability.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-14. (canceled)

15. A self-closing emergency coupling and release device for the transport of cryogenic fluid, comprising:
two fluid transport ducts extending in a longitudinal direction, and each comprising, at a connection end, a valve mechanism which is configured to close the duct automatically when the connection ends are separated, and to open the duct when the connection ends are coupled;
an outer tube which is placed around each transport duct, and defines a space under vacuum for thermal insulation of the transport duct; and
a mechanism for holding the transport duct in the outer tube,
wherein the holding mechanism comprises a frustoconical connection tube, with a first end that is connected to the outer tube and a second end that is connected to the transport duct,
wherein the first end of the connection tube is connected to the outer tube at an annular outer flange that is fitted at the terminal end of said outer tube,
wherein the annular outer flange is configured to cooperate in a sealed manner with the adjacent outer flange when the connection ends are coupled,
wherein the second end of the connection tube is connected to the transport duct at an annular inner flange that is fitted at the terminal end of said transport duct,
wherein the inner flange is configured to cooperate in a non-sealed manner with the adjacent inner flange when the connection ends are coupled, in order to permit the migration of any leakages of cryogenic fluid, and form a pocket of gas at the junction of, and/or between the connection tubes of, the two coupled connection ends.

16. The device as claimed in claim 15, wherein the connection tube has a thickness of between 0.3 mm and 0.5 mm and a length of between 10 mm and 500 mm, and constitutes an insulating thermal path between the two ends thereof.

17. The device as claimed in claim 15, wherein the second end of the connection tube of a first one of the two ducts is situated in the interior of the outer tube to which it is connected, whereas the second end of the connection tube of the other one of the two ducts projects on the exterior of the outer tube to which it is connected, such as to form a nesting system of the male and female type

18. The device as claimed in claim 15, wherein at least one of the first and second ends of the connection tube comprises a guide part, for example with an annular form, which is designed to come into contact with the tube or a flange of the other duct during the coupling.

19. The device as claimed in claim 18, wherein the at least one guide part is composed of a material with a low coefficient of friction, for example lower than 0.3, relative to the tube or to the flange, coming into contact during the coupling, the material being for example PTFE.

20. The device as claimed in claim 18, wherein the at least one guide part is configured to ensure sealed contact with the tube or the flange of the other duct during the coupling.

21. The device as claimed in claim 15, wherein the valve mechanism comprises a valve, which is thrust towards a position of closure against a seat by a return unit.

22. The device as claimed in claim 15, wherein the seat comprises a seal which is designed to cooperate with the valve, in order to ensure the sealing in the position of closure.

23. The device as claimed in claim 22, wherein the seal of the seat is situated on the inner flange, on a face of said inner flange, which faces towards the interior of the transport duct.

24. The device as claimed in claim 22, wherein the terminal ends of the valves of the two transport ducts are configured to come into contact with one another, and to force one another back mechanically out of the respective seats, against the return units, when the connection ends are coupled.

25. The device as claimed in claim 15, wherein the inner flange is secured on the end of the inner tube via a set of fitting units such as screws, which, during dismantling of the flange, permit access to the mechanism of the valve and of the seals of the device.

26. The device as claimed in claim 15, wherein the support tube comprises a plurality of portions of tube connected in series between the first end, which is connected to the outer tube, and the second end, which is connected to the transport duct.

27. The device as claimed in claim 26, wherein the plurality of connected portions of tube forming the support tube comprises two portions of tube, which are convergent in opposite directions according to the direction of transport of the fluid.

28. The device as claimed in claim 15, wherein the space under vacuum between the outer tube and the transport duct comprises a multilayer thermal insulator “MLI”.
